(19) United States
(12) Patent Application Publication
(10) Pub. No.: US 2016/0048647 A1
(43) Pub. Date: Feb. 18, 2016

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Daigo AIZAWA, Kanagawa (JP)

(21) Appl. No.: 14/602,794

(22) Filed: Jan. 22, 2015

(30) Foreign Application Priority Data
Aug. 18, 2014 (JP) 2014-165776

(51) Int. Cl. G06F 19/00

(52) U.S. Cl. CPC G06F 19/345; G06F 19/3418

(57) ABSTRACT

An information processing apparatus includes an extracting unit and a generating unit. The extracting unit extracts a clinical path format for a medical condition of a target patient in accordance with medical-condition identification information enabling identification of the medical condition and region identification information enabling identification of a region to which the patient belongs. The generating unit generates a clinical path by inserting medical care information into the clinical path format extracted by the extracting unit, the medical care information being information regarding medical care for the medical condition of the patient.

### CROSS-REFERENCE TO RELATED APPLICATIONS

This application is based on and claims priority under 35 USC 119 from Japanese Patent Application No. 2014-165776 filed Aug. 18, 2014.

### BACKGROUND

1. Technical Field

The present invention relates to an information processing apparatus, an information processing method, and a non-transitory computer readable medium.

2. Related Art

### SUMMARY

According to an aspect of the invention, there is provided an information processing apparatus including an extracting unit and a generating unit. The extracting unit extracts a clinical path format for a medical condition of a target patient in accordance with medical-condition identification information enabling identification of the medical condition and region identification information enabling identification of a region to which the patient belongs. The generating unit generates a clinical path by inserting medical care information into the clinical path format extracted by the extracting unit, the medical care information being information regarding medical care for the medical condition of the patient.

### BRIEF DESCRIPTION OF THE DRAWINGS

An exemplary embodiment of the present invention will be described in detail based on the following figures, wherein:

FIG. 1 is a diagram conceptually illustrating a module configuration in a configuration example of the exemplary embodiment;

FIG. 2 is an explanatory diagram illustrating an example of a system configuration implemented by the exemplary embodiment;

FIG. 3 is an explanatory diagram illustrating an example of a data structure of a medical-condition management table;

FIG. 4 is an explanatory diagram illustrating an example of a data structure of a document-template management table;

FIG. 5 is an explanatory diagram illustrating an example of a data structure of a patient-information table;

FIG. 6 is an explanatory diagram illustrating an example of a data structure of a medical-care-information management table;

FIG. 7 is an explanatory diagram illustrating an example of a data structure of a hospital-information management table;

FIG. 8 is an explanatory diagram illustrating an example of a data structure of a region management table;

FIG. 9 is an explanatory diagram illustrating an example of a data structure of a keyword table;

FIG. 10 is a flowchart illustrating an example of processing according to the exemplary embodiment;

FIG. 11 is an explanatory diagram illustrating an example of the processing according to the exemplary embodiment;

FIG. 12 is an explanatory diagram illustrating an example of displaying a clinical path;

FIG. 13 is a flowchart illustrating an example of processing according to the exemplary embodiment;

FIG. 14 is an explanatory diagram illustrating an example of the processing according to the exemplary embodiment;

FIG. 15 is a flowchart illustrating an example of the processing according to the exemplary embodiment;

FIG. 16 is an explanatory diagram illustrating an example of the processing according to the exemplary embodiment;

FIG. 17 is a flowchart illustrating an example of the processing according to the exemplary embodiment;

FIG. 18 is an explanatory diagram illustrating an example of the processing according to the exemplary embodiment; and

FIG. 19 is a block diagram illustrating an example of a hardware configuration of a computer that implements the exemplary embodiment.

### DETAILED DESCRIPTION

Hereinafter, examples of an exemplary embodiment of the invention will be described with reference to the drawings.

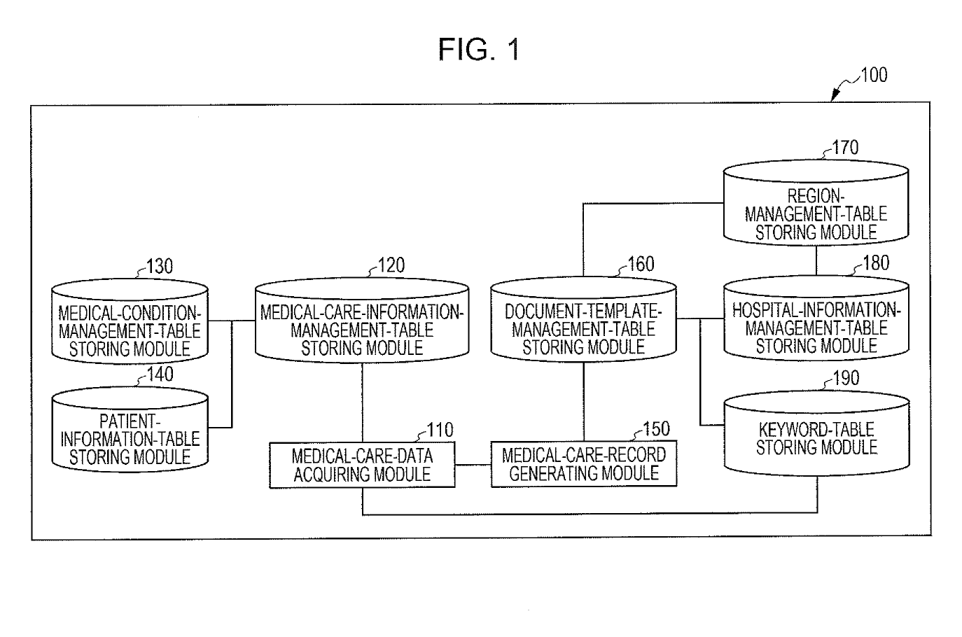

FIG. 1 is a diagram conceptually illustrating a module configuration in a configuration example of the exemplary embodiment.

Note that the term “module” refers to generally logically separable components of software (computer programs) and hardware or the like. Modules in the exemplary embodiment thus refer to not only modules in a computer program but also modules in a hardware configuration. Accordingly, the description of the exemplary embodiment also serves as a description of a computer program for causing a computer to function as the modules (a program for causing a computer to execute steps, a program for causing a computer to function as components, and a program for causing a computer to implement functions) as well as a system and a method therefor. Meanwhile, the term “to store” and other terms equivalent to “to store” are used in descriptions. In a case where the exemplary embodiment describes a computer program, the term means storing something in a storage device or controlling something so as to store something in a storage device. The modules are provided for respective functions on a one-to-one basis. However, in implementing the functions, one program may constitute one module; one program may constitute multiple modules; and multiple programs may constitute one module. In addition, one computer may run multiple modules, and multiple computers may run one module in a distributed or parallel processing environment. Note that one module may include another module. Moreover, the term “connection” is used for not only a physical connection but also a logical connection (such as data exchange, instructions, or a reference relationship among data pieces). The term “predetermined” refers to having been determined before target processing. This term is used in such a manner as to include the meaning of being determined according to the situation at the determination time or to the situation thus far only before target processing, regardless of whether before or even after the start of processing in the present exemplary embodiment. Meanwhile, in a case of multiple “predetermined values”, the values may be different from one another, or two or more of the values may be the same (including all of the values). Moreover, an expression meaning “if A, then B” is used in such a manner as to mean that “it is determined whether A holds true, and if it is determined that A holds true, then B is performed”. However, this excludes a case where the determination of whether A holds true is not needed.

A system or a device includes not only a configuration in which multiple computers, hardware, devices, and the like are connected to each other through a communication unit such as a network (including a communication connection on an one-to-one basis), but also a configuration in which a computer, hardware, a device, or the like is implemented. The terms “device” and “system” are used as terms having the same meaning. It goes without saying that the “system” does not include a mere social “system” built in accordance with agreements worked out by humans.

In addition, to perform a processing operation or multiple processing operations in each module, the module reads target information from a storage device for each processing, performs the processing, and writes a processing result to the storage device. Accordingly, explanations of reading the content from the storage device before processing and writing the content to the storage device after the processing are omitted in some cases. Here, the storage device may include a hard disk, a random access memory (RAM), an external storage medium, a storage device connected through a communication network, a register in a central processing unit (CPU), and other devices.

An information processing apparatus 100 according to the exemplary embodiment generates a clinical path and includes, as illustrated in the example in FIG. 1, a medical-care-data acquiring module 110, a medical-care-information-management-table storing module 120, a medical-condition-management-table storing module 130, a patient-information-table storing module 140, a medical-care-record generating module 150, a document-template-management-table storing module 160, a region-management-table storing module 170, a hospital-information-management-table storing module 180, and a keyword-table storing module 190.

Note that a clinical path is a medical-care plan document generated on a per-medical-condition-type basis and an electronic document that describes the state of a patient and a standard medical-care plan including aims, evaluations, and records of medical actions (hereinafter, also referred to simply as a document). The clinical path may be used to provide support for implementing medical care in accordance with a standard medical-care plan, record states and evaluations of medical care on a per-patient basis, and perform processing of tallying and analyzing cases deviating from the standard plan and the like.

In medical practice, regional medical institutions have been positively building up a “regional medical liaison” system to provide efficient and effective treatments. The regional medical institutions have been dividing their roles in accordance with their functions, scales, or characteristics and cooperating with each other. In the regional medical liaison system, a “clinical path (regional liaison path)” is used. Medical-care institutions (such as hospitals) administer treatments to patients in accordance with plans/details of treatments specified by clinical paths. However, the hospitals use electronic medical charts in order to manage actual treatment records. In a case where a clinical path is used without the exemplary embodiment, the content of an electronic medical chart needs to be transferred to the clinical path. Accordingly, a treatment using the clinical path requires more labor to generate a new document than a treatment not using the clinical path. Moreover, the format of a clinical path varies with the medical condition, and thus different handling is required depending on the medical condition. Further, there is a case where hospitals in the same medical region use different formats, and thus different handling might also be required depending on the hospital.

The medical-care-record generating module 150 is connected to the medical-care-data acquiring module 110 and the document-template-management-table storing module 160. The medical-care-record generating module 150 extracts the format of a clinical path of a medical condition (hereinafter, also referred to as a template) of a target patient from the document-template-management-table storing module 160 in accordance with medical-condition identification information enabling identification of a medical condition of the target patient and region identification information enabling identification of a region to which the patient belongs. Then, the medical-care-record generating module 150 generates a clinical path (document also serving as a medical care record) in such a manner as to insert medical care information as being information regarding medical care for the medical condition of the patient into the extracted format of the clinical path, the medical care information being acquired by the medical-care-data acquiring module 110. When the medical care information is “inserted”, the medical care information per se (raw information yet to be processed) may be embedded in (also referred to as to “be run into”) the format of the clinical path, or the medical care information may be processed and then be embedded in the format of the clinical path.

In addition, a clinical path may be generated in a document format, and thus the clinical path is enabled to be shared among different medical institutions. Examples of the document format include a format of a document generated by word processing software and a portable document format (PDF).

The medical-care-data acquiring module 110 is connected to the medical-care-information-management-table storing module 120, the medical-care-record generating module 150, and the keyword-table storing module 190. The medical-care-data acquiring module 110 acquires medical care data associated with the medical condition from the medical-care-information-management-table storing module 120. Then, the medical-care-data acquiring module 110 extracts information associated with the patient including a predetermined word associated with the medical condition (hereinafter, also referred to as a keyword) from the medical-care-information-management-table storing module 120 and the like and delivers the information to the medical-care-record generating module 150. Then, the medical-care-record generating module 150 generates a clinical path in such a manner as to add, to the clinical path, the information (information associated with the patient) received from the medical-care-data acquiring module 110. Specifically, for example, a predetermined word is designated by a first medical institution that generates the clinical path or a second medical institution that receives the clinical path. The second medical institution may only be a medical institution that is to perform a treatment for the medical condition after the first medical institution has performed a treatment. For example, in a case where the first medical institution is a hospital that has performed a treatment for the medical condition in the acute stage, the second medical institution is a hospital that is to perform a treatment for the medical condition in the convalescent stage. In another example, in a case where the first medical institution is a hospital that has performed a treatment for the medical condition in the convalescent stage, the second medical institution is a hospital that is to perform a treatment for the medical condition in the chronic stage. Which medical institution has designated the keyword is stored in a keyword table 900 to be described later with reference to, for example, an example in FIG. 9.

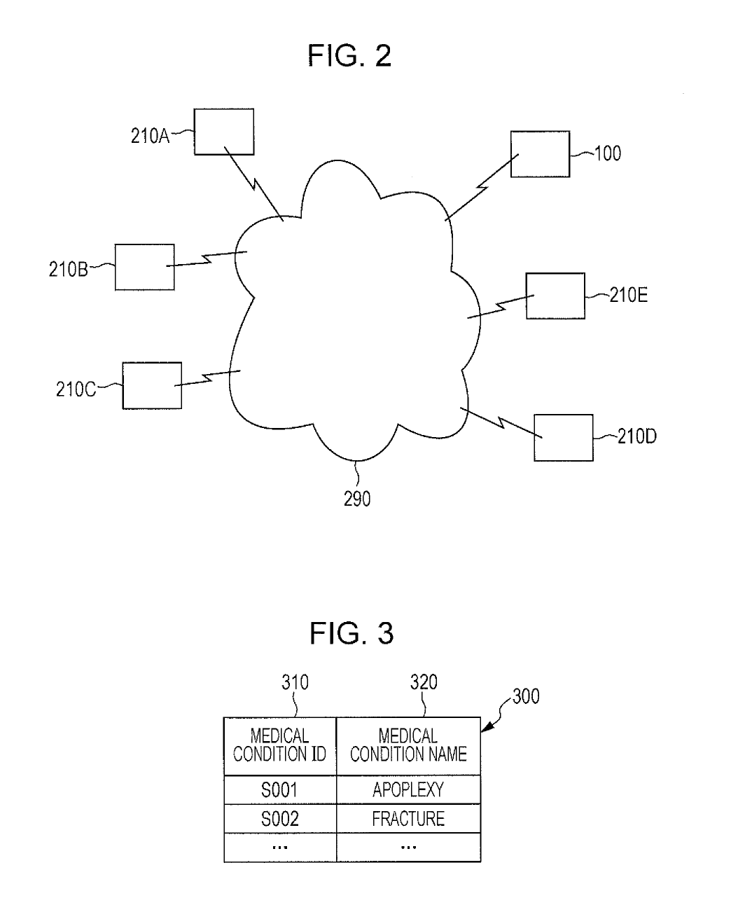

The medical-medical-condition-management-table storing module 130 is connected to the medical-care-information-management-table storing module 120. For example, a medical-condition management table 300 is stored in the medical-condition-management-table storing module 130. FIG. 3 is an explanatory diagram illustrating an example of a data structure of the medical-condition management table 300. The medical-condition management table 300 has a medical-condition-ID column 310 and a medical-condition-name column 320 and is a table for managing pieces of medical condition information. Pieces of information (medical condition IDs) for uniquely identifying medical conditions in the exemplary embodiment are stored in the medical-condition-ID column 310. Medical condition names indicated by the respective medical condition IDs are stored in the medical-condition-name column 320.

The patient-information-table storing module 140 is connected to the medical-care-information-management-table storing module 120. For example, a patient-information table 500 is stored in the patient-information-table storing module 140. FIG. 5 is an explanatory diagram illustrating an example of a data structure of the patient-information table 500. The patient-information table 500 has a patient-ID column 510 and a patient-name column 520 and is a table for managing pieces of patient information. Pieces of information (patient IDs) for uniquely identifying patients in the exemplary embodiment are stored in the patient-ID column 510. Patient names assigned the respective patient IDs are stored in the patient-name column 520.

The medical-care-information-management-table storing module 120 is connected to the medical-care-data acquiring module 110, the medical-condition-management-table storing module 130, and the patient-information-table storing module 140. For example, a medical-care-information management table 600 is stored in the medical-care-information-management-table storing module 120. FIG. 6 is an explanatory diagram illustrating an example of a data structure of the medical-care-information management table 600. The medical-care-information management table 600 has a medical-condition-ID column 610, a treatment-ID column 620, a patient-ID column 630, and a record column 640 and is a table for managing pieces of medical care data associated with the medical conditions. The medical-care-information management table 600 may be generated in such a manner that pieces of data are extracted from a system for managing medical care records such as electronic medical charts. The medical condition IDs are stored in the medical-condition-ID column 610. Pieces of information (treatment IDs) for uniquely identifying treatments performed for the medical conditions respectively assigned the medical condition IDs in the exemplary embodiment are stored in the treatment-ID column 620. The patient IDs respectively assigned to the patients who receive any of the treatments respectively assigned the treatment IDs are stored in the patient-ID column 630. Records of treatments (such as specific details of treatments) each identified from corresponding fields of the medical-condition-ID column 610, the treatment-ID column 620, and the patient-ID column 630 are stored in the record column 640.

The region-management-table storing module 170 is connected to the hospital-information-management-table storing module 180 and the document-template-management-table storing module 160. For example, a region management table 800 is stored in the region-management-table storing module 170. FIG. 8 is an explanatory diagram illustrating an example of a data structure of the region management table 800. The region management table 800 has a region-ID column 810 and a region-name column 820 and manages pieces of region information. Pieces of information (region IDs) for uniquely identifying regions in the exemplary embodiment are stored in the region-ID column 810. Region names assigned the respective region IDs are stored in the region-name column 820.

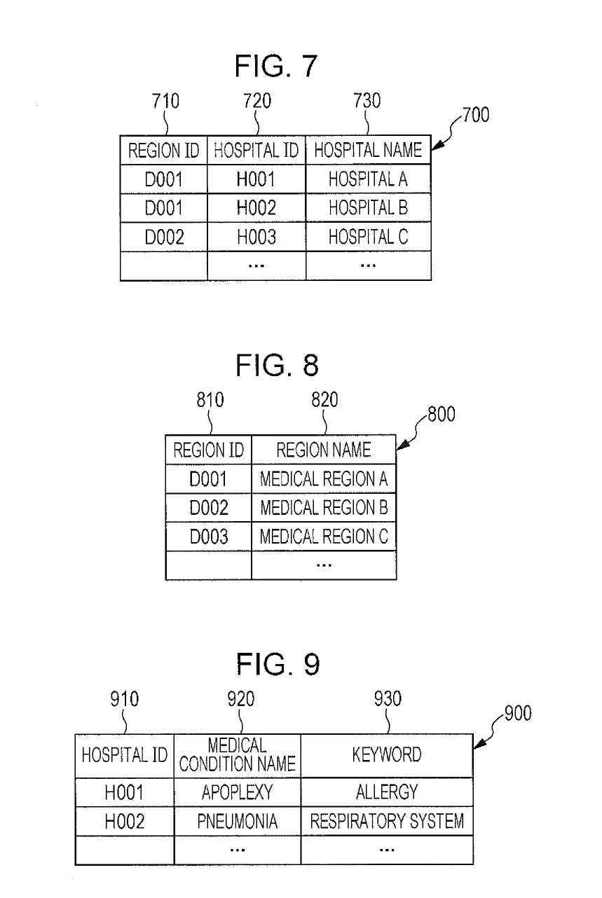

The hospital-information-management-table storing module 180 is connected to the document-template-management-table storing module 160 and the region-management-table storing module 170. For example, a hospital-information management table 700 is stored in the hospital-information-management-table storing module 180. FIG. 7 is an explanatory diagram illustrating an example of a data structure of the hospital-information management table 700. The hospital-information management table 700 has a region-ID column 710, a hospital-ID column 720, and a hospital-name column 730 and is a table for managing pieces of hospital information. The region IDs are stored in the region-ID column 710. Pieces of information (hospital IDs) for uniquely identifying hospitals in the regions respectively assigned the region IDs in the exemplary embodiment are stored in the hospital-ID column 720. Hospital names respectively assigned the hospital IDs are stored in the hospital-name column 730.

The keyword-table storing module 190 is connected to the medical-care-data acquiring module 110 and the document-template-management-table storing module 160. For example, the keyword table 900 is stored in the keyword-table storing module 190. FIG. 9 is an explanatory diagram illustrating an example of a data structure of the keyword table 900. The keyword table 900 has a hospital-ID column 910, a medical-condition-name column 920, and a keyword column 930. In the keyword table 900, keywords considered to be useful for medical care have been registered. Examples of the keywords include a symptom directly or indirectly related to a medical condition. The hospital IDs are stored in the hospital-ID column 910. The medical condition names are stored in the medical-condition-name column 920. Keywords associated with the respective medical conditions and designated by the hospitals respectively assigned the hospital IDs are stored in the keyword column 930.

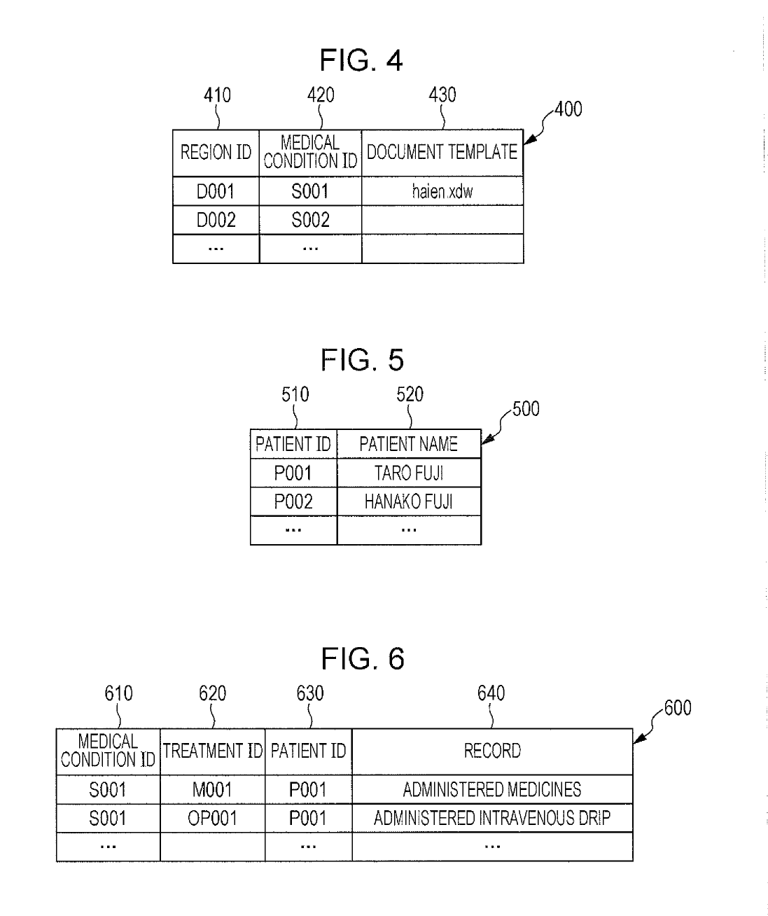

The document-template-management-table storing module 160 is connected to the medical-care-record generating module 150, the region-management-table storing module 170, the hospital-information-management-table storing module 180, and the keyword-table storing module 190. For example, a document-template management table 400 is stored in the document-template-management-table storing module 160. Since the document-template-management-table storing module 160 has prepared the formats of the clinical paths, documents in different formats may be handled on a per-medical-condition basis (further on a per-region basis). FIG. 4 is an explanatory diagram illustrating an example of a data structure of the document-template management table 400. The document-template management table 400 has a region-ID column 410, a medical-condition-ID column 420, and a document-template column 430 and is a table for managing templates of clinical paths provided on a per-region basis and on a per-medical-condition basis. The region IDs are stored in the region-ID column 410. The medical condition IDs are stored in the medical-condition-ID column 420. The formats of the clinical paths (document templates) of the respective medical conditions assigned the medical condition IDs in the regions assigned the region IDs are stored in the document-template column 430. Note that the formats or sites (link information) in which the formats are stored may be stored in the document-template column 430.

FIG. 2 is an explanatory diagram illustrating an example of a system configuration implemented by the exemplary embodiment.

The information processing apparatus 100, a hospital information system A 210A, a hospital information system B 210B, a hospital information system C 210C, a hospital information system D 210D, and a hospital information system E 210E are connected to each other through a communication network 290. Each of the hospital information systems 210A to 210E is installed in a hospital, but may be a medical information system installed in a medical institution other than a hospital, such as a doctor's office or a clinic. Each of the hospital information systems 210A to 210E may also be combined with the information processing apparatus 100. The communication network 290 may be a wireless network, a wired network, or a network obtained by combining the wireless and wired networks and may be, for example, the Internet serving as a communication infrastructure.

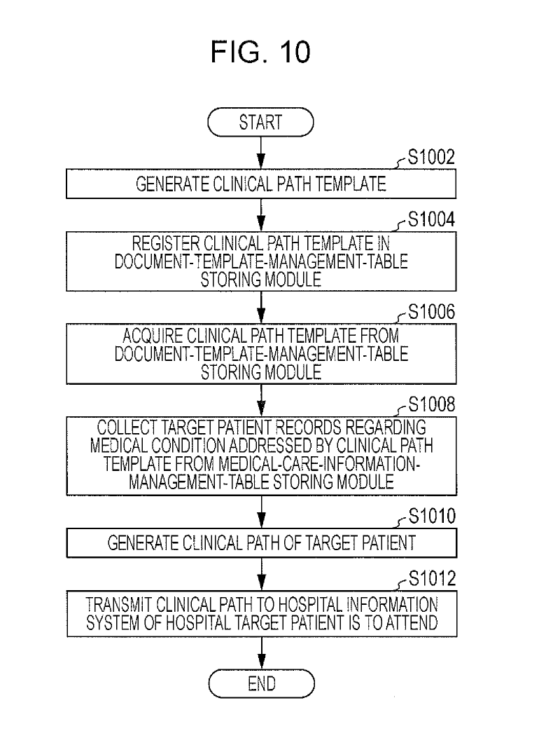

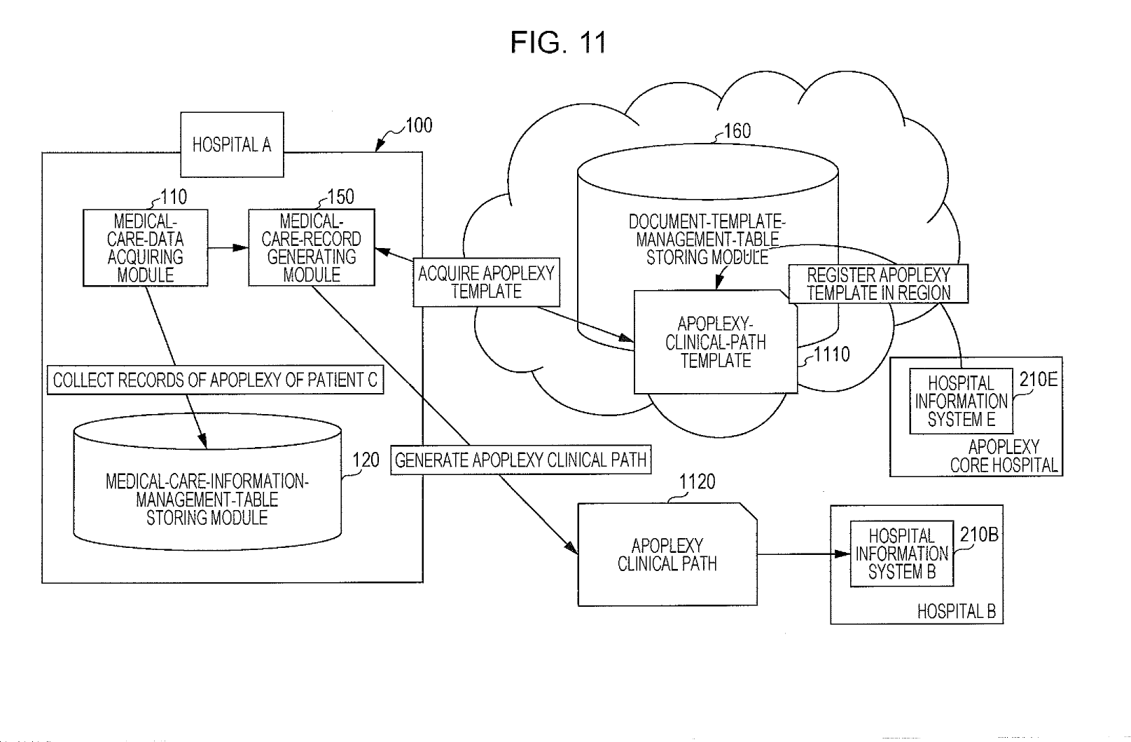

FIG. 10 is a flowchart illustrating an example of processing according to the exemplary embodiment. The processing example will be described by using, as a target medical condition, apoplexy illustrated in an example in FIG. 11.

In step S1002, the hospital information system E 210E of an apoplexy core hospital generates an apoplexy-clinical-path template 1110 in accordance with an operation of an operator (expert). The apoplexy core hospital is a hospital designated in advance on a per-region basis.

In step S1004, the hospital information system E 210E registers the apoplexy-clinical-path template 1110 in the document-template-management-table storing module 160. The processing performed up to this step is so-call pre-processing (preparation). Note that the document-template-management-table storing module 160 may be implemented as a storage device connected through a communication network (by using a so-called cloud service).

In step S1006, the medical-care-record generating module 150 of a hospital A acquires the apoplexy-clinical-path template 1110 from the document-template-management-table storing module 160. For example, the hospital A is a hospital at which apoplexy surgeries have been performed. The medical-care-record generating module 150 acquires a clinical path template that is the apoplexy-clinical-path template 1110 associated with apoplexy and the hospital A (region).

In step S1008, the medical-care-data acquiring module 110 collects target patient records regarding the medical condition addressed by the clinical path template, from the medical-care-information-management-table storing module 120. An example of the records regarding the medical condition is an apoplexy surgery record.

In step S1010, the medical-care-record generating module 150 generates an apoplexy clinical path 1120 of the target patient.

In step S1012, the medical-care-record generating module 150 transmits the apoplexy clinical path 1120 to the hospital information system B 210B of a hospital B the target patient is to attend as an outpatient. For example, the hospital B is a hospital that is to perform a treatment in the convalescent stage of apoplexy, and a hospital closer to the patient's house than the hospital A is generally selected as the hospital B.

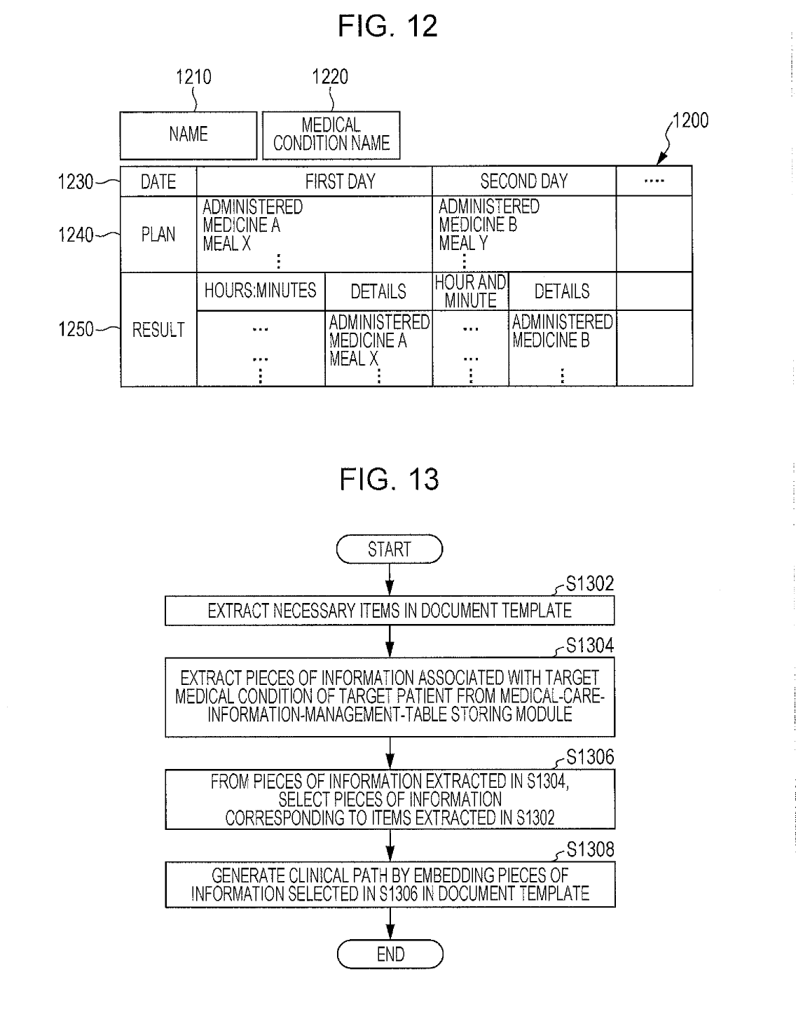

FIG. 12 is an explanatory diagram illustrating an example of displaying a clinical path generated by the medical-care-record generating module 150.

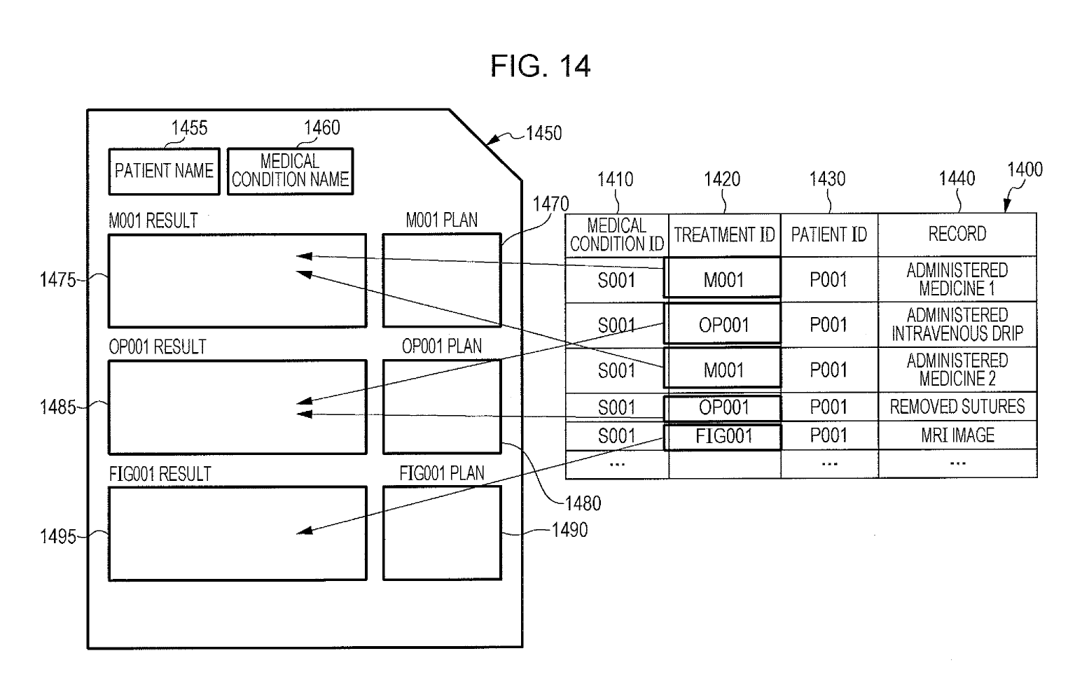

The clinical path includes a patient-name field 1210, a medical-condition-name field 1220, and a clinical-path detail area 1200. The clinical-path detail area 1200 includes a date row 1230, a plan row 1240, and a result row 1250 and has different content depending on the region and the medical condition. For example, treatment plans for the medical condition have been described in advance in the plan row 1240 in the template. In contrast, treatments that have been actually performed are recorded in the result row 1250. It goes without saying that the result row 1250 has blank fields corresponding to dates on which treatments are to be performed. Note that entries are arranged in order of date in the clinical path illustrated in the example in FIG. 12, but may be arranged on a per-treatment basis as in an example in FIG. 14 (described later).

FIG. 13 is a flowchart illustrating an example of processing according to the exemplary embodiment (an example of clinical-path generation processing).

In step S1302, the medical-care-record generating module 150 extracts necessary items in a document template.

In step S1304, the medical-care-data acquiring module 110 extracts pieces of information associated with a target medical condition of a target patient from the medical-care-information-management-table storing module 120.

In step S1306, the medical-care-record generating module 150 selects pieces of information corresponding to the items extracted in step S1302 from the pieces of information extracted in step S1304.

In step S1308, the medical-care-record generating module 150 generates the clinical path in such a manner as to embed the pieces of information selected in step S1306 in the document template.

The processing in the example in FIG. 13 will be described by using an example in FIG. 14. FIG. 14 is an explanatory diagram illustrating an example of the processing according to the exemplary embodiment.

A document template 1450 is a template of a clinical path of a specific medical condition (assigned a medical condition ID of S001) in a region including a hospital where a patient has been treated. The document template 1450 has a patient-name field 1455, a medical-condition-name field 1460, an M001 plan field 1470, an M001 result field 1475, an OP001 plan field 1480, an OP001 result field 1485, an FIG. 001 plan field 1490, and an FIG. 001 result field 1495. Treatments that have been actually performed are inserted into the M001 result field 1475, the OP001 result field 1485, and the FIG. 001 result field 1495 of the document template 1450. Note that planned treatments are described in advance in the M001 plan field 1470, the OP001 plan field 1480, and the FIG. 001 plan field 1490.

Treatment IDs for the M001 result field 1475, the OP001 result field 1485, and the FIG. 001 result field 1495 are extracted from the document template 1450 (step S1302). Specifically, a treatment ID of M001, a treatment ID of OP001, and a treatment ID of FIG. 001 are extracted.

A medical-care-information management table 1400 is obtained by extracting pieces of information associated with a target patient (assigned a patient ID of P001) and a target medical condition (assigned a medical condition ID of S001) (step S1304) from the medical-care-information management table 600. Like the medical-care-information management table 600, the medical-care-information management table 1400 has a medical-condition-ID column 1410, a treatment-ID column 1420, a patient-ID column 1430, and a record column 1440.

Pieces of data (associated with the treatment ID of M001) in the first and third rows of the medical-care-information management table 1400 are extracted for the M001 result field 1475, pieces of data (associated with the treatment ID of OP001) in the second and fourth rows are extracted for the OP001 result field 1485, and a piece of data (associated with the treatment ID of FIG. 001) in the fifth row is extracted for the FIG. 001 result field 1495 (step S1306).

Then, the pieces of data (associated with the treatment ID of M001) in the first and third rows of the medical-care-information management table 1400 are embedded in the M001 result field 1475, the pieces of data (associated with the treatment ID of OP001) in the second and fourth rows are embedded in the OP001 result field 1485, and the piece of data (associated with the treatment ID of FIG. 001) in the fifth row is embedded in the FIG. 001 result field 1495 (step S1308).

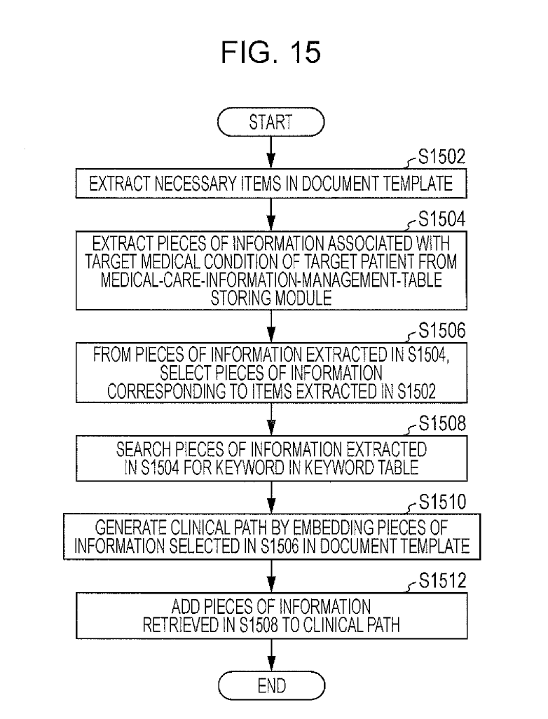

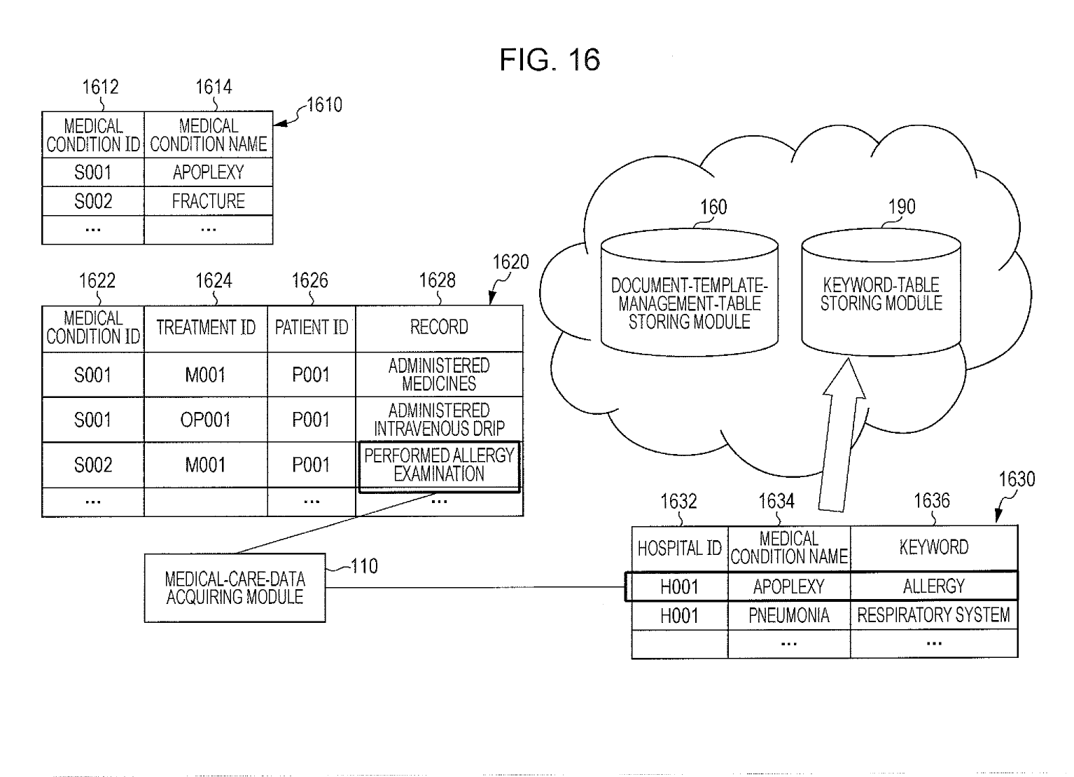

FIG. 15 is a flowchart illustrating an example of the processing according to the exemplary embodiment (another example of the clinical-path generation processing). Note that the processing operations in steps S1502 to S1506, and S1510 correspond to the steps in the flowchart in the example in FIG. 13.

In step S1502, the medical-care-record generating module 150 extracts necessary items in a document template.

In step S1504, the medical-care-data acquiring module 110 extracts pieces of information associated with a target medical condition of a target patient from the medical-care-information-management-table storing module 120.

In step S1506, the medical-care-record generating module 150 selects pieces of information corresponding to the items extracted in step S1502 from the pieces of information extracted in step S1504.

In step S1508, a specific keyword in the keyword table 900 is searched for in the pieces of information extracted in step S1504.

In step S1510, a clinical path is generated in such a manner that the pieces of information selected in step S1506 are embedded in the document template.

In step S1512, one or more pieces of information retrieved in step S1508 are added to the clinical path.

The processing in the example in FIG. 15 will be described by using an example in FIG. 16. FIG. 16 is an explanatory diagram illustrating an example of the processing according to the exemplary embodiment.

In the processing, a medical care record associated with an allergy is also acquired. This is because a keyword “allergy” is associated with apoplexy (assigned the medical condition ID of S001) in a keyword table 1630 although “performed allergy examination” in a medical-care-information management table 1620 is not associated with apoplexy assigned the medical condition ID of S001.

A medical-condition management table 1610 has a medical-condition-ID column 1612 and a medical-condition-name column 1614 and corresponds to the medical-condition management table 300.

The medical-care-information management table 1620 has a medical-condition-ID column 1622, a treatment-ID column 1624, a patient-ID column 1626, and a record column 1628 and corresponds to the medical-care-information management table 600. The medical-care-information management table 1620 has pieces of data associated with the extracted patient ID of P001.

The keyword table 1630 is stored in the keyword-table storing module 190. The keyword table 1630 has a hospital-ID column 1632, a medical-condition-name column 1634, and a keyword column 1636 and corresponds to the keyword table 900.

Since the medical condition “apoplexy” is associated with a keyword “allergy” in the row having a hospital ID of H001 (a first medical-care institution or a second medical-care institution) in the keyword table 1630, the medical-care-data acquiring module 110 extracts a row including “allergy” that is also included in the record column 1628 (the row including a medical condition ID of S002 in the medical-care-information management table 1620) of the medical-care-information management table 1620 (step S1508). Then, the medical-care-record generating module 150 inserts the piece of information (“performed allergy examination”) in the row into the template (step S1512). Incidentally, a medical condition “fracture” is assigned the medical condition ID of S002 associated with “performed allergy examination” (see the medical-condition management table 1610) and has nothing to do with the medical condition “apoplexy”. However, the hospital ID of H001 requires the information as useful information for apoplexy treatments.

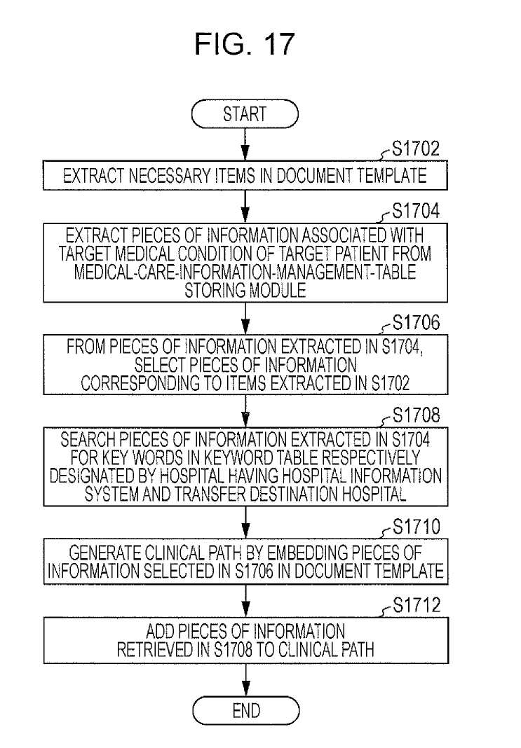

FIG. 17 is a flowchart illustrating an example of the processing according to the exemplary embodiment. Note that processing operations in steps S1702 to S1706, and S1710 correspond to the steps in the flowchart illustrated in the example in FIG. 13.

In step S1702, the medical-care-record generating module 150 extracts necessary items in the document template.

In step S1704, the medical-care-data acquiring module 110 extracts pieces of information associated with a target medical condition of a target patient from the medical-care-information-management-table storing module 120.

In step S1706, the medical-care-record generating module 150 selects pieces of information corresponding to the items extracted in step S1702 from the pieces of information extracted in step S1704.

In step S1708, keywords in the keyword table that are designated by a hospital using the processing and a hospital to which the patient is to be transferred are searched for in the pieces of information extracted in step S1704.

In step S1710, a clinical path is generated in such a manner that the pieces of information selected in step S1706 are embedded in the document template.

In step S1712, the pieces of information retrieved in step S1508 are added to the clinical path.

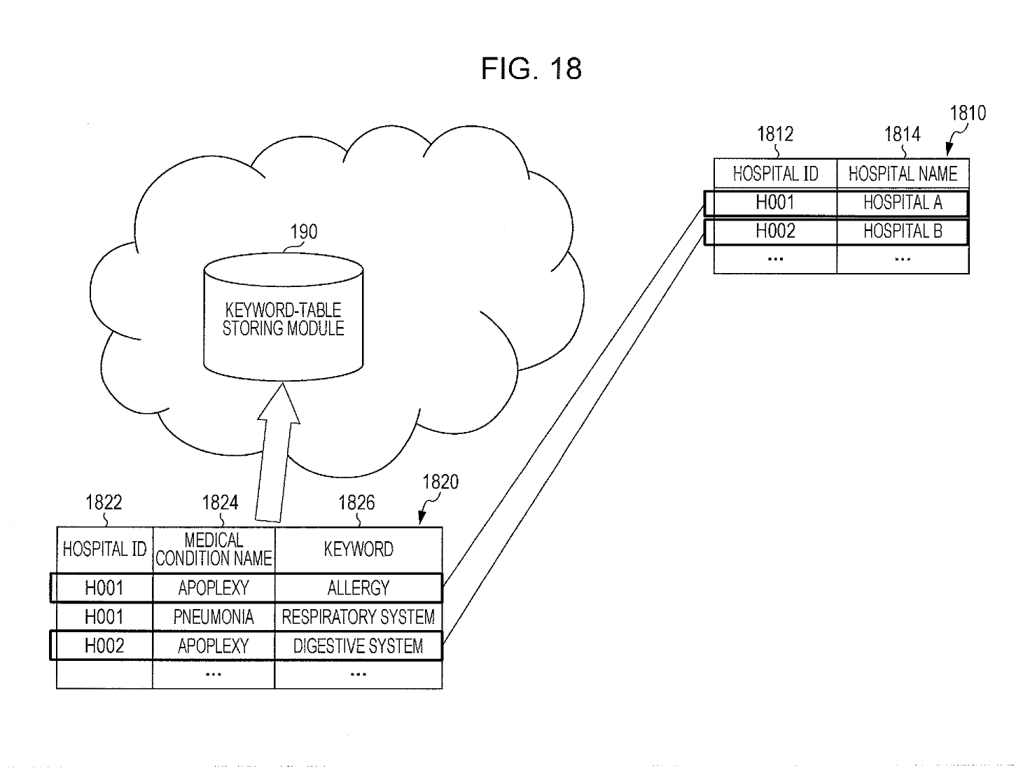

The processing in the example in FIG. 17 will be described by using an example in FIG. 18. FIG. 18 is an explanatory diagram illustrating an example of the processing according to the exemplary embodiment.

Each hospital registers a keyword the hospital considers to be useful in a keyword table 1820 in the keyword-table storing module 190 in a cloud system. For example, in a case where the hospital A delivers a clinical path to the hospital B (in a case where the target patient is transferred from the hospital A to the hospital B), the keywords respectively registered by the hospital A and the hospital B are searched for in medical care records of the hospital A, and retrieved information is added to the clinical path.

The processing is provided under the following assumption. In the case where the hospital A delivers the clinical path to the hospital B, the hospital A wishes to provide the hospital B with specific information, or the hospital B wishes to receive specific information from the hospital A; however, an item for the information is not provided in the template of the clinical path.

A hospital management table 1810 is a table for managing hospitals in the same region and has a hospital-ID column 1812 and a hospital-name column 1814 that correspond to the hospital-ID column 720 and the hospital-name column 730, respectively, in the hospital-information management table 700.

A keyword table 1820 is stored in the keyword-table storing module 190. The keyword table 1820 has a hospital-ID column 1822, a medical-condition-name column 1824, and a keyword column 1826 and corresponds to the keyword table 900.

The hospital A (assigned the hospital ID of H001) that is the first medical-care institution designates the keyword “allergy” for “apoplexy”, while the hospital B (assigned a hospital ID of H002) that is the second medical-care institution designates a keyword “digestive system” for “apoplexy”.

Since the medical condition “apoplexy” is associated with the keyword “allergy” in the row having the hospital ID of H001 in the keyword table 1820, the medical-care-data acquiring module 110 extracts a row including “allergy” that is also included in the record column 640 of the medical-care-information management table 600. In addition, since the medical condition “apoplexy” is associated with the keyword “digestive system” in the row having the hospital ID of H002, the medical-care-data acquiring module 110 extracts a row including “digestive system” that is also included in the record column 640 of the medical-care-information management table 600 (step S1708). Then, the medical-care-record generating module 150 inserts the pieces of information in the rows into the template (step S1712).

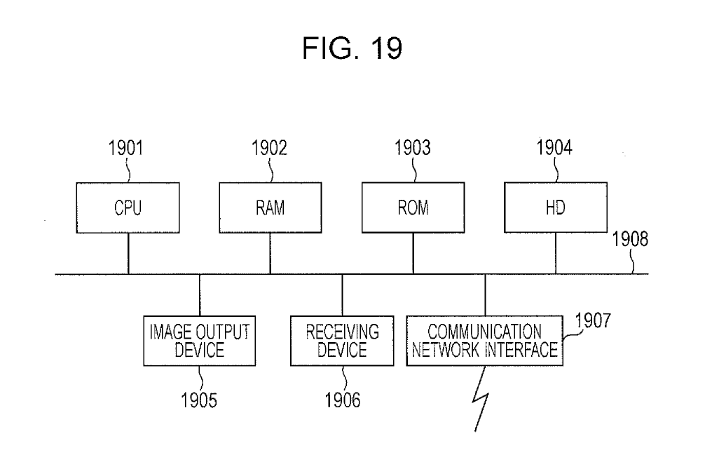

Meanwhile, a computer that executes a program according to the exemplary embodiment has a hardware configuration of a general computer, as illustrated in FIG. 19, specifically, a personal computer, a computer enabled to serve as a server, or other computers. In a specific example, the computer uses a CPU 1901 as a processing unit (arithmetic operation unit), and a RAM 1902, a ROM 1903, and a hard disk (HD) 1904 as storage devices. The computer may use, for example, a hard disk or a solid state drive (SSD) as the HD 1904. In addition to the CPU 1901, the RAM 1902, the ROM 1903, and the HD 1904, the computer includes a receiving device 1906, an image output device 1905 such as a cathode-ray tube (CRT) or a liquid crystal display, a communication network interface 1907, such as a network interface card, for connecting to a communication network, and a bus 1908 for connecting these components to exchange data. The CPU 1901 executes programs such as the medical-care-data acquiring module 110 and the medical-care-record generating module 150. The programs and data are stored in the RAM 1902. A program for starting the computer and the like is stored in the ROM 1903. The HD 1904 is an auxiliary storage device (may be a flash memory or other device). The receiving device 1906 receives data in accordance with user input via a keyboard, a mouse, a touch panel, or another device. Multiple computers each serving as the computer above may be mutually connected through a network.

The exemplary embodiment regarding the computer program described above is implemented in such a manner that a system in the hardware configuration described above reads computer programs that are software, i.e., in such a manner that the software and the hardware resources work in cooperation with each other.

The hardware configuration in FIG. 19 merely illustrates a configuration example, and the exemplary embodiment is not limited to the configuration in FIG. 19. As long as a configuration enables the modules described in the exemplary embodiment to be run, the configuration may be employed. For example, at least one of the modules may be configured to run on hardware dedicated to the module (such as an application specific integrated circuit (ASIC)). At least one of the modules may be in an external system to be connected through a communication network. Further, multiple systems each serving as the system in FIG. 19 may be mutually connected through a communication network to work in cooperation with each other. In particular, the configuration may be incorporated in not only a personal computer but also a personal digital electronics, a copier, a fax machine, a scanner, a printer, a multifunctional product (image processing device having two or more functions of a scanner, a printer, a copier, or a fax machine), and other devices.

Note that the program described above may be provided by using a recording medium having the program recorded therein, and may be provided by using a communication unit. In this case, for example, the program described above may be regarded as an exemplary embodiment of the invention of a “non-transitory computer readable medium having a program recorded therein”.

The “non-transitory computer readable medium having a program recorded therein” refers to a computer readable recording medium having a program recorded therein that is used for installation, execution, distribution, and the like of a program.

Examples of the recording medium include a digital versatile disk (DVD) supporting “DVD-R, DVD-RW, DVD-RAM, and the like” that are standards designated by the DVD Forum and “DVD+R, DVD+RW, and the like” that are standards designated in accordance with “DVD+RW; a compact disc (CD) such as a CD read-only memory (CD-ROM), a CD recordable (CD-R), a CD rewritable (CD-RW), or the like; a Blu-ray (registered trademark) disc; a magneto-optical disk (MO); a flexible disk (FD); a magnetic tape; a hard disk; a ROM; an electrically erasable and programmable ROM (EEPROM (registered trademark)); a flash memory; a RAM; and a secure digital (SD) memory card.

The aforementioned program or part of the program may also be saved on the recording medium to be stored or distributed. The program or part thereof may be transmitted through communication by using a transmission medium such as a wired network used for a local area network (LAN), a metropolitan area network (MAN), a wide area network (WAN), the Internet, an intranet, an extranet, or the like; a wireless communication network; or a combination of these. Alternatively, the program or part thereof may be transmitted by using carrier signals.

Further, the program may be part of another program, or may be saved on a recording medium together with another program. The program may also be divided to be saved on multiple recording media. The program may be saved in any manner such as by being compressed or encrypted, as long as the program is restorable.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an extracting unit that extracts a clinical path format for a medical condition of a target patient in accordance with medical-condition identification information enabling identification of the medical condition and region identification information enabling identification of a region to which the patient belongs; and
a generating unit that generates a clinical path by inserting medical care information into the clinical path format extracted by the extracting unit, the medical care information being information regarding medical care for the medical condition of the patient.

2. The information processing apparatus according to claim 1, wherein
the generating unit generates the clinical path by adding information associated with the patient to the clinical path, the information including a predetermined word associated with the medical condition.

3. The information processing apparatus according to claim 2, wherein
the predetermined word is designated by a first medical institution that generates the clinical path or a second medical institution that receives the clinical path.

4. An information processing method comprising:
extracting a clinical path format for a medical condition of a target patient in accordance with medical-condition identification information enabling identification of the medical condition and region identification information enabling identification of a region to which the patient belongs; and
generating a clinical path by inserting medical care information into the extracted clinical path, the medical care information being information regarding medical care for the medical condition of the patient.

5. A non-transitory computer readable medium storing a program causing a computer to execute a process comprising:
extracting a clinical path format for a medical condition of a target patient in accordance with medical-condition identification information enabling identification of the medical condition and region identification information enabling identification of a region to which the patient belongs; and
generating a clinical path by inserting medical care information into the extracted clinical path, the medical care information being information regarding medical care for the medical condition of the patient.
